(19) United States
(12) Patent Application Publication
(10) Pub. No.: US 2016/0304377 A1
(43) Pub. Date: Oct. 20, 2016

(54) EXPEDITIONARY WASTEWATER RECYCLING SYSTEM

(71) Applicants: DANIEL M. EARLY, NEW CASTLE, VA (US); SCOTT F. EASTER, HUDDLESTON, VA (US)

(72) Inventors: DANIEL M. EARLY, NEW CASTLE, VA (US); SCOTT F. EASTER, HUDDLESTON, VA (US)

(21) Appl. No.: 15/096,221

(22) Filed: Apr. 11, 2016

Related U.S. Application Data
(60) Provisional application No. 62/150,221, filed on Apr. 20, 2015.

(51) Int. Cl. C02F 9/00; C02F 1/76; A47K 11/02; C02F 3/12; C02F 3/20; E03F 11/00; C02F 1/32; C02F 3/08

(52) U.S. Cl. CPC C02F 9/00; C02F 1/325; C02F 1/76; C02F 3/087; C02F 3/1268; C02F 3/20; E03F 11/00; A47K 11/02; C02F 2103/005

(57) ABSTRACT

The expeditionary wastewater recycling system is a portable, self-contained system adapted for deployment in the field for use by expeditionary military forces. The system includes a tank that is divided into three separate internal volumes. The first volume serves as a primary clarification chamber, the second contains a moving bed biological reactor (MBBR), and the third contains a membrane biological reactor (MBR). Blackwater from the latrine flows through the three chambers, and further treatment is provided by ultraviolet and chlorine treatment units. The system may be deployed between the latrine and a conventional liquid storage bladder. Processed water flows to another storage bladder provided with the system, and the conventional bladder serves as an overflow container. The system is completely contained within a standard shipping container, and additional volume within the container serves to store the collapsed bladder, hoses, fittings, and/or other equipment.

### CROSS-REFERENCE TO RELATED APPLICATIONS

This application claims the benefit of U.S. Provisional Patent Application Serial No. 62/150,221, filed on Apr. 20, 2015.

### BACKGROUND OF THE INVENTION

1. Field of the Invention

The present invention relates generally to wastewater treatment, and particularly to an expeditionary wastewater recycling system providing multiple water cleaning and recycling functions and contained in a standardized shipping container to facilitate deployment for expeditionary forces in the field.

2. Description of the Related Art

Temporary facilities for handling the sanitation needs of a large number of people in the field have been a chronic problem for the military and others responsible for such needs. Restroom facilities are generally handled by portable toilets for outdoor events and the like where a large number of people are gathered for a relatively short time, i.e., part of a day up to perhaps a week. However, deployment of military personnel at forward operating bases generally results in stays in the field that last for months or perhaps a year or more. While portable or in-ground toilets might serve as a stopgap measure in such circumstances, the continual need to pump out such toilets and the need to dispose of the collected sewage and its accompanying sanitation problems renders such an approach as impracticable at best.

Accordingly, various portable self-contained wastewater collection facilities have been developed in the past, primarily for the military. Latrines are generally installed in facilities having the dimensions of standardized shipping containers and may be assembled to form tricons, or triple containers, having dimensions of approximately eight feet wide by eight feet high by slightly less than twenty feet in length, i.e., the size of a standard twenty foot long ISO shipping container. Field latrines are also available in expandable tricons as well. This enables the system to be shipped or transported conveniently to nearly any location. Much the same applies to mess kitchen and shower facilities and the like. However, such systems cannot provide for wastewater or sewage treatment or reclamation on site. The wastewater or sewage resulting from the use of such facilities is collected in a three thousand gallon storage bladder. The collected graywater (from wash facilities) or blackwater (i.e., sewage, from latrines) is periodically collected from the storage bladder by a tank truck or other means and hauled away for disposal at a treatment plant or other facility.

Thus, an expeditionary wastewater recycling system solving the aforementioned problems is desired.

### SUMMARY OF THE INVENTION

The expeditionary wastewater recycling system is a self-contained system that is particularly adapted for the treatment and recycling of blackwater effluent from a military latrine facility in the field. The system is contained in a standardized shipping container having nominal dimensions of about eight feet wide by eight feet high by six and one half feet in horizontal depth. A closed wastewater treatment tank is installed within the shipping container, the treatment tank being divided internally into three vertically disposed chambers.

The first chamber serves as a primary clarification chamber, allowing solids to settle out of suspension. The second chamber serves as a moving bed biological reactor, or MBBR having myriad buoyant plastic media therein. The plastic media collectively provide a large surface area for microbial growth for the biological breakdown of waste. The third chamber serves as a membrane biological reactor (MBR) and contains a membrane filtration system that further treats and filters the effluent passing therethrough.

Various pumps, aerators, ultraviolet disinfection unit, chlorine disinfection unit, and other subsystems may be provided with the above system, all contained within the standard shipping container. The operation of the system is controlled by a programmable logic controller, and a control panel (also known as a Human-Machine Interface, or HMI) provides information on the operation and allows for input by the operator.

The shipping container may also provide for the storage of additional articles therein. Sufficient room is provided in the container for a deflated and folded three thousand gallon liquid storage bladder in one area thereof, and for various pipes, hoses, valves, and/or tools and other equipment in another area thereof. Thus, when the system is set up in the field, the storage bladder and various pipes, valves and hoses may be connected to the output of the conventional latrine between its grinder pump station and its conventional storage bladder. Treated effluent flows to the first storage bladder provided with the wastewater treatment system or is surface discharged onsite. The conventional storage bladder of the latrine then serves as an emergency storage bladder. The treated water issuing from the system is non-potable, but is suitable for a number of other purposes, such as wetting down surfaces for dust control and/or washing or rinsing down various articles of equipment. This is particularly valuable in relatively arid areas of the world, where it is difficult to secure large quantities of water and wasteful to use potable water for such general use.

These and other features of the present invention will become readily apparent upon further review of the following specification and drawings.

### BRIEF DESCRIPTION OF THE DRAWINGS

FIG. 1 is a perspective view of an expeditionary wastewater recycling system according to the present invention, illustrating various features thereof.

FIG. 2 is a left side elevation view of the expeditionary wastewater recycling system according to the present invention, illustrating various outlets and vents and the addition of a chlorine dispensing device thereto.

FIG. 3 is a right side elevation view of the expeditionary wastewater recycling system according to the present invention, shown with the front and rear doors and top hatches open.

FIG. 4 is a perspective view of the expeditionary wastewater recycling system according to the present invention, shown with the front doors open to show various components therein.

FIG. 5 is a front elevation view of the expeditionary wastewater recycling system according to the present invention, shown with the front doors open to show further details thereof

FIG. 6 is a section view along lines 6-6 of FIG. 5.

FIG. 7 is a section view along lines 7-7 of FIG. 6.

FIG. 8 is a schematic drawing of an expeditionary wastewater recycling system according to the present invention, showing the system in communication with a conventional latrine and blackwater collection system.

Similar reference characters denote corresponding features consistently throughout the attached drawings.

### DETAILED DESCRIPTION OF THE PREFERRED EMBODIMENTS

The expeditionary wastewater recycling system is a completely portable unit configured particularly for use by expeditionary military forces in the field, but adaptable for other uses as well. The system is contained within a standard size shipping container having nominal dimensions of about eight feet wide by eight feet high by six and one half feet in horizontal depth, i.e., front to rear. Ancillary components, e.g., an additional storage bladder, hoses, valves, fittings, etc., may be contained in storage compartments provided within the container.

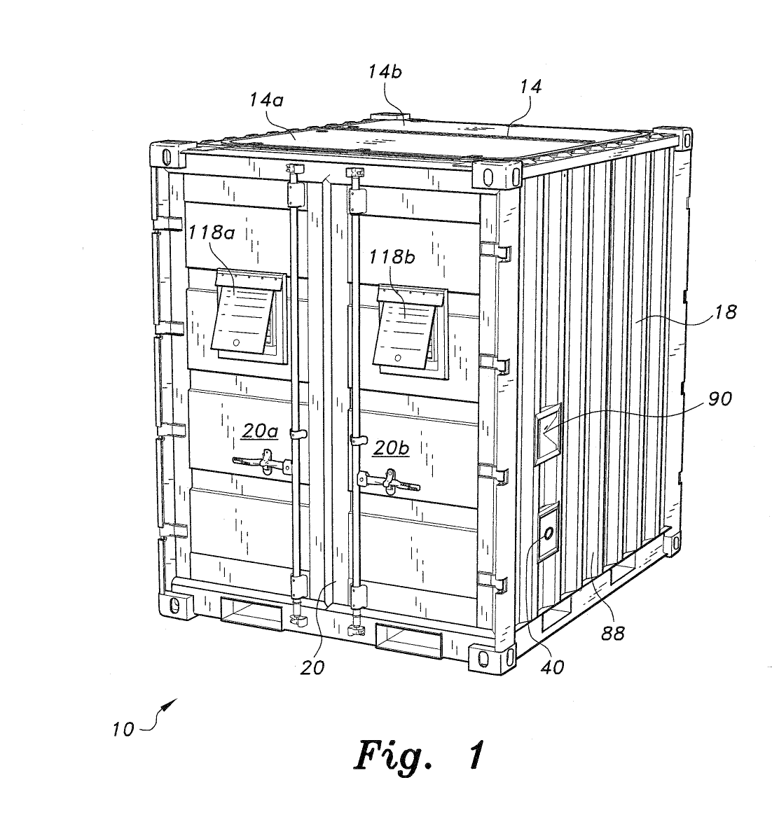

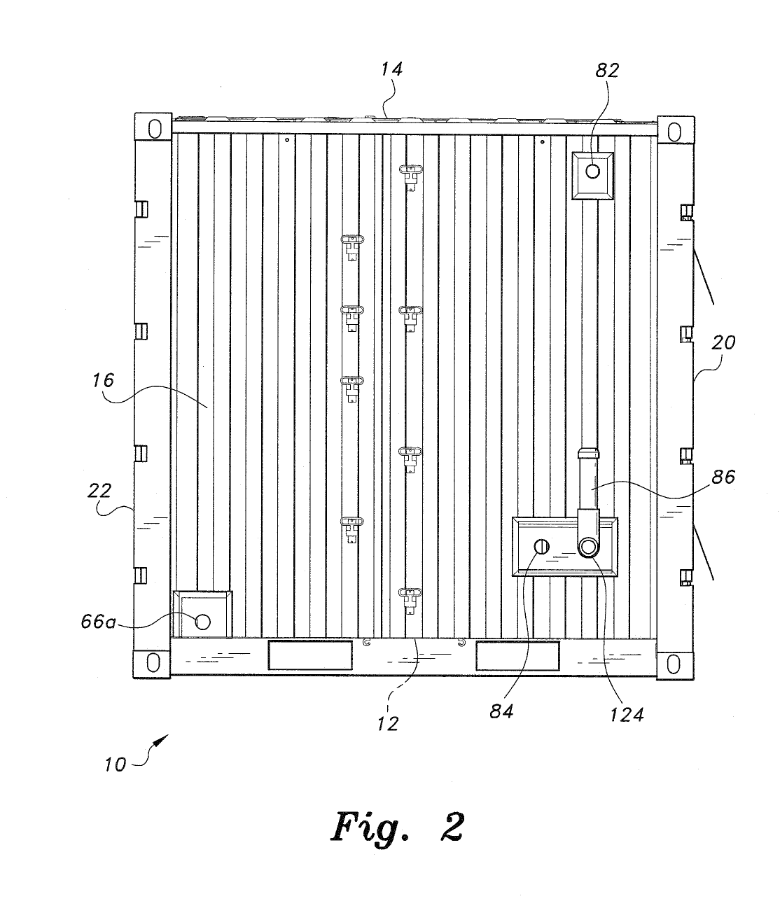

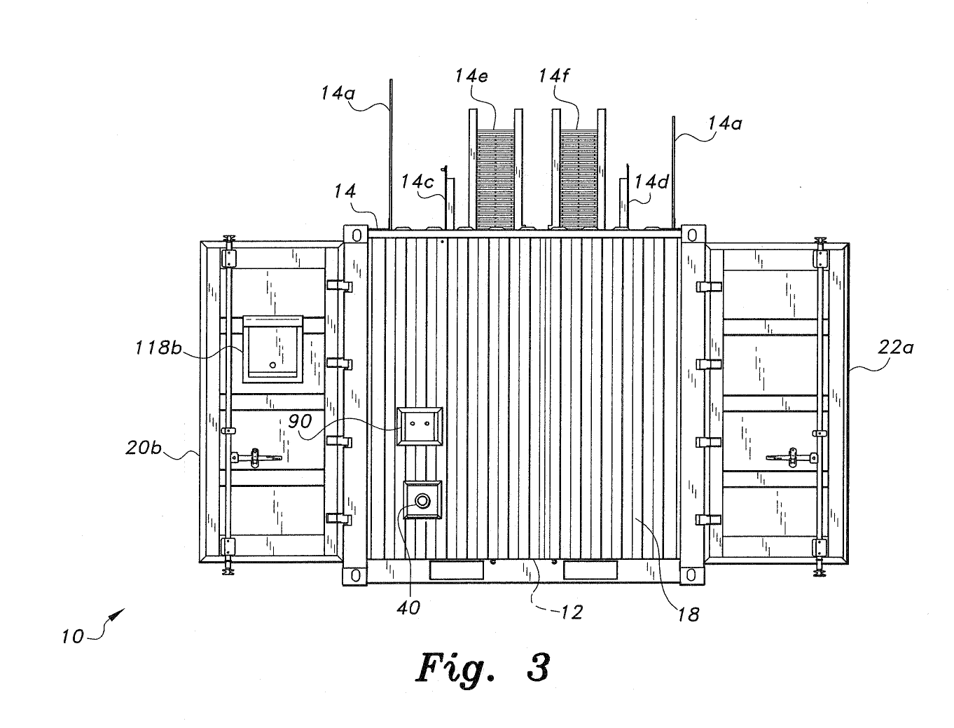

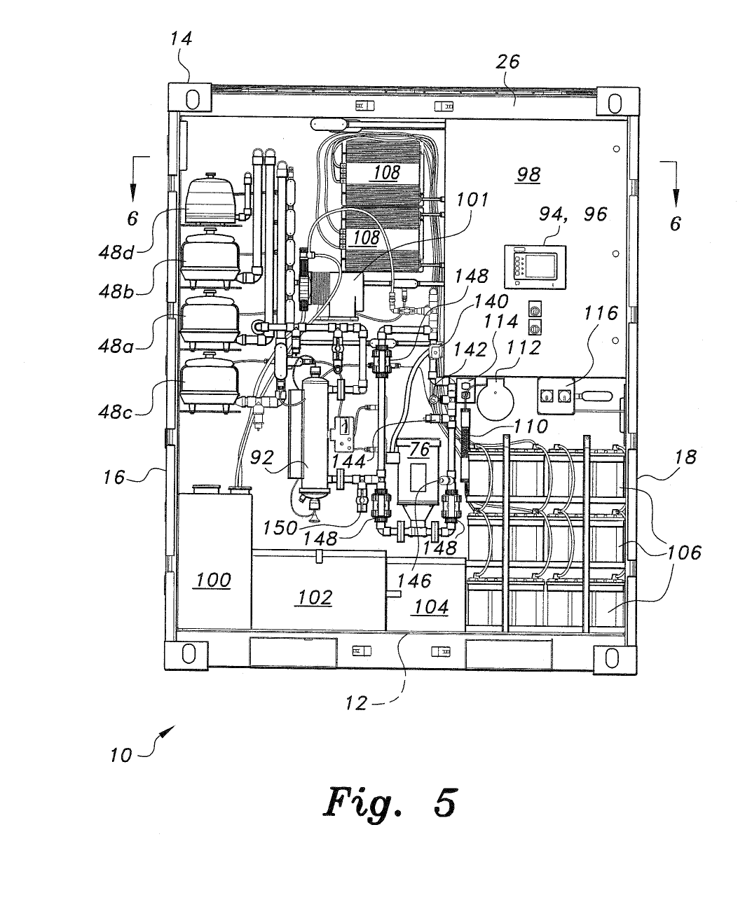

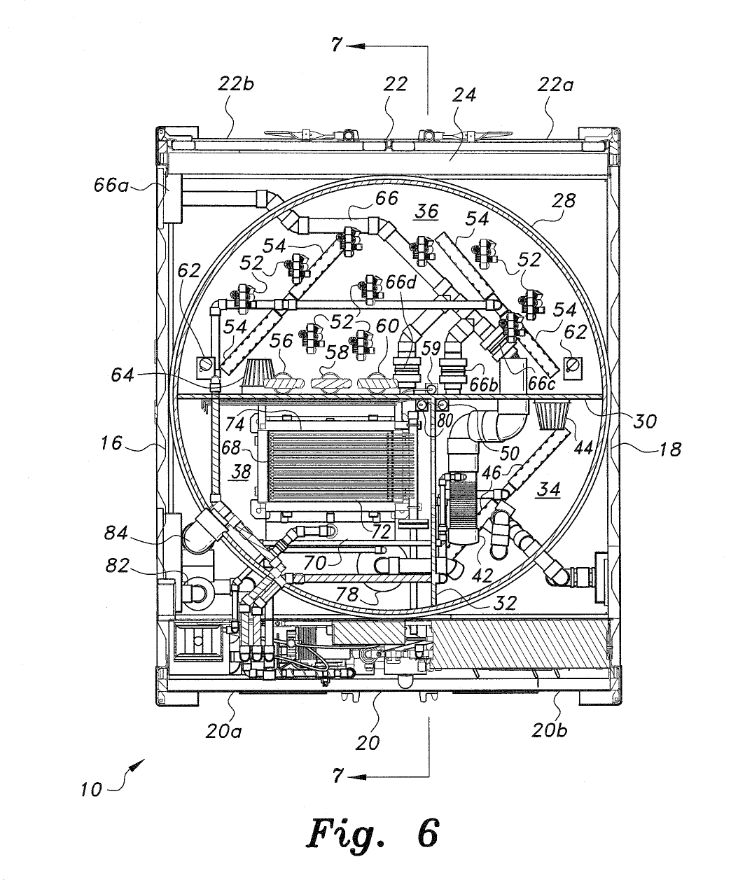

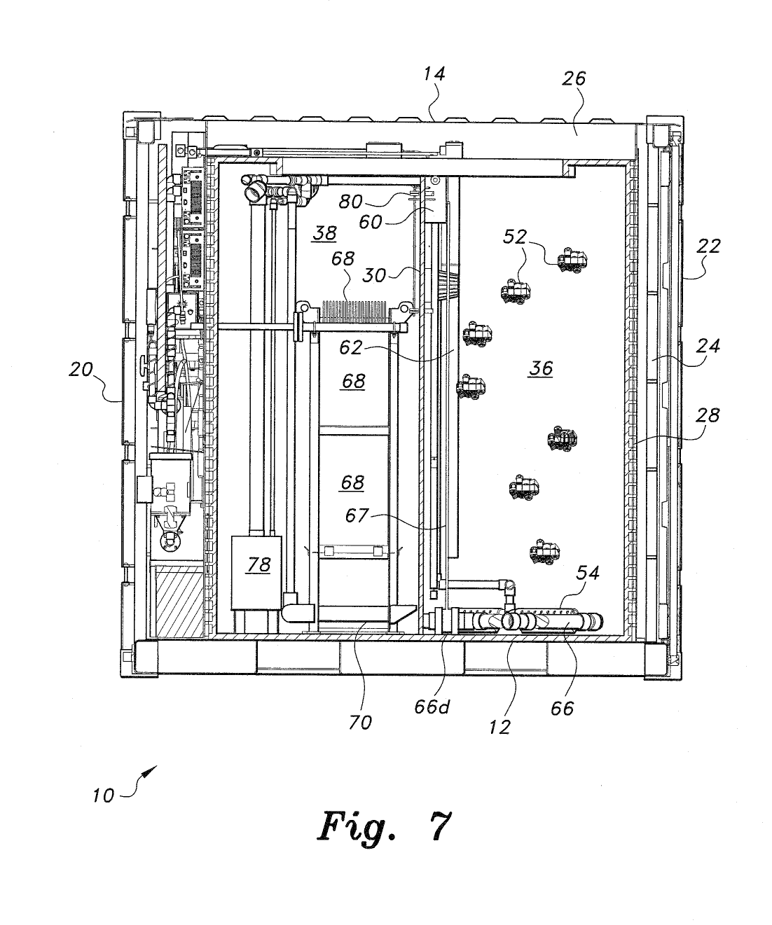

FIGS. 1 through 4 of the drawings provide external views of the portable shipping container 10 containing the wastewater recycling system. The container 10 includes a floor 12 (FIGS. 2, 3, 5, and 7), a top or roof 14 opposite the floor 12, mutually opposed first and second sides 16 and 18, and mutually opposed front and back panels 20 and 22 (FIGS. 2, 6 and 7). The front panel 20 preferably includes two doors 20a and 20b, with the back panel 22 also preferably having two doors 22a and 22b for access to a rear storage compartment 24 (FIGS. 6 and 7). The top or roof 14 has two oppositely hinged access panels 14a and 14b, providing access to a shallow top storage compartment 26 (FIGS. 5 and 7). Top access to the wastewater treatment tank 28 contained within the container 10 and described in detail further below, is provided by additional interior access panels 14c and 14d. Two hinged safety grates 14e and 14f provide additional safety for persons working atop the container 10 when the interior access panels 14c and 14d are open, as shown in FIG. 3. The safety grates 14e and 14f are shown raised in FIG. 3. The above-described container 10 is in the general form of a three-dimensional rectangular solid when all doors and panels are closed, but other shapes and configurations may be adapted for use with the wastewater recycling system.

A wastewater treatment tank 28 is installed within the container 10, as shown in the top plan view of FIG. 6. The rear storage compartment 24 is located between the effluent recycling tank 28 and the doors 22a, 22b of the back panel or wall 22. The tank 28 has a height somewhat less than the height of the container 10, with the top storage compartment 26 disposed between the top of the tank 28 and the overlying panels 14a, 14b of the top or roof 14. The tank 28 may have the form of a vertical cylinder, as shown, or other form or shape as desired.

Two vertically disposed panels 30 and 32 divide or separate the interior volume of the tank 28 into three separate chambers 34, 36, and 38, counterclockwise from the first chamber 34 to the lower right in FIG. 6. The first chamber 34 comprises a primary clarifier chamber that receives partially processed blackwater (sewage) from a source external to the container 10 through an inlet 40, immediately below the external electrical power connectors 90 (shown in FIGS. 1 and 3). An aerated bar screen 42 removes buoyant solids from the blackwater, with an emergency overflow port or screen 44 obviating overfilling of the first chamber 34 in the event that the bar screen 42 becomes clogged or is disabled. Coarse air diffusers 46 are submerged in the bottom of the first or primary clarifier chamber 34, with a pneumatic pump 48a (FIG. 5) external to the tank 28 providing air for periodic aeration and mixing of the blackwater in the chamber 34. Water level in the first or primary clarifier chamber 34 is monitored by a high water float switch 50 located in the primary clarifier chamber 34.

The partially treated wastewater flows from the first or primary clarifier chamber 34 to the second or moving bed biological reactor (MBBR) chamber 36. This is the largest of the three chambers 34 through 38, by volume. This second chamber 36 includes a large number of free floating plastic media 52 upon which microbial growth will occur to form a biofilm on each of the plastic media. The large number of such plastic media 52 in the second or MBBR chamber 36 provides a very large surface area for such microbial growth. Submerged coarse air diffusers 54 are installed in the second or MBBR chamber 36 to circulate the effluent therein and agitate the plastic media 52 for optimum effect, with a pneumatic pump 48b (FIG. 5) adjacent to the previously noted pump 48a providing air for the diffusers 54. This second chamber 36 includes various sensors and monitors as well. A pressure transducer 56, pH probe 58, ORP (Oxidation Reduction Potential) probe 60, temperature sensor 59, and immersion heaters 62 are disposed within the second or MBBR chamber 36 to further monitor and control conditions therein. Another media screen 64 is installed in the second chamber 36, similar to the screen 44 of the first or primary clarifier chamber 34. A drain manifold 66 and drain outlet 66a are also provided for the system, as shown in the second chamber 36 in FIG. 6; the drain 66a is also shown in FIGS. 2, 4, and 8. The drain manifold 66 terminates with three valves 66b, 66c, and 66d that drain each of the three chambers 34, 36, and 38 respectively. Each valve is operated remotely, e.g., via a mechanical rod 67 or other linkage or a solenoid, to preclude any need to physically enter the tank 28 in order to operate the valve(s).

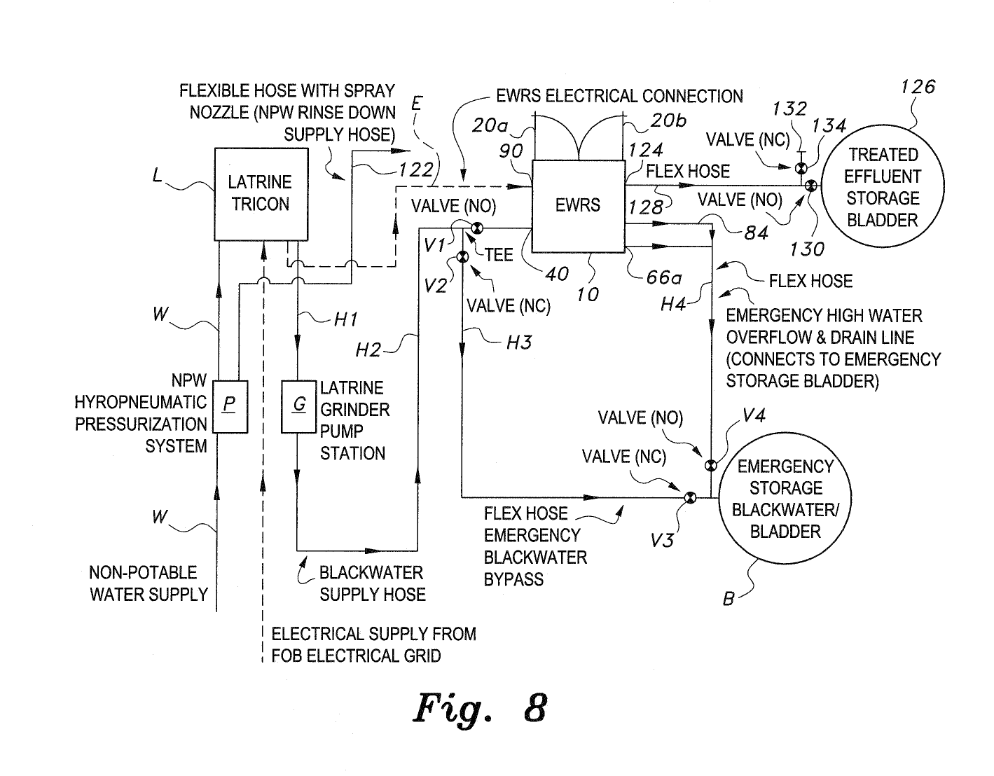

The partially treated wastewater then flows from the second or MBBR chamber 36 to the third or MBR (Membrane Biological Reactor) chamber 38 of the wastewater treatment tank 28. A membrane filtration assembly 68 is installed within the third or MBR chamber 38 (also shown in FIG. 7), and serves to further filter solids from the effluent. The membrane filtration assembly 68 is preferably capable of filtering particulates down to .08 microns. However, other filter capabilities or capacities may be provided as desired. It will be seen that the extremely fine filtration provided by the membrane filtration assembly 68 requires a constant air scour in order to keep the upstream or inlet membrane face clear of particulates and microbial growth. Accordingly, a linear air pump 48c (FIG. 5) adjacent to pump 48a is provided to pump air to a diffuser assembly 70 at the inlet side or face 72 of the membrane filtration assembly 68. The mixing provided by the diffuser 70 also assists in promoting further biological breakdown of the wastewater contained within the third or MBR chamber 38. Permeate is drawn through the membrane filtration assembly from the outlet side or face 74 thereof by a permeate pump 76 (FIG. 5) external to the tank 28, which is part of a complete permeate pump assembly. The permeate pump assembly comprises an electric solenoid valve 140, pressure gauge 142, pressure transducer 144, flow meter 146, union ball valves 148, permeate pump 76, and sampling port 150. The third or MBR chamber 38 also contains an airlift pump 78, with this pump communicating with the first or primary clarifier chamber 34 to periodically circulate the wastewater therein during periods without incoming flow. Air is supplied to the airlift pump 78 by pneumatic pump 48d (FIG. 5) external to the tank 28, located near the previously noted pneumatic pumps 48a through 48c. Water level in the third or MBR chamber 38 is monitored and controlled by the pressure transducer 56 located in the chamber 36. Backup high and low water float switch 80, similar to the float switch 50 in the first or primary clarifier chamber 34, is provided in the event that the pressure transducer 56 is out of commission. A vent 82 and overflow outlet 84 are also provided from the third or MBR chamber 38. The main or primary outlet from the tank 28 and container 10 is located on the lower right side of the container 10 near the forward or front panel 20, as shown in FIG. 2, and indicated schematically in FIG. 8 in the schematic drawing of the entire system.

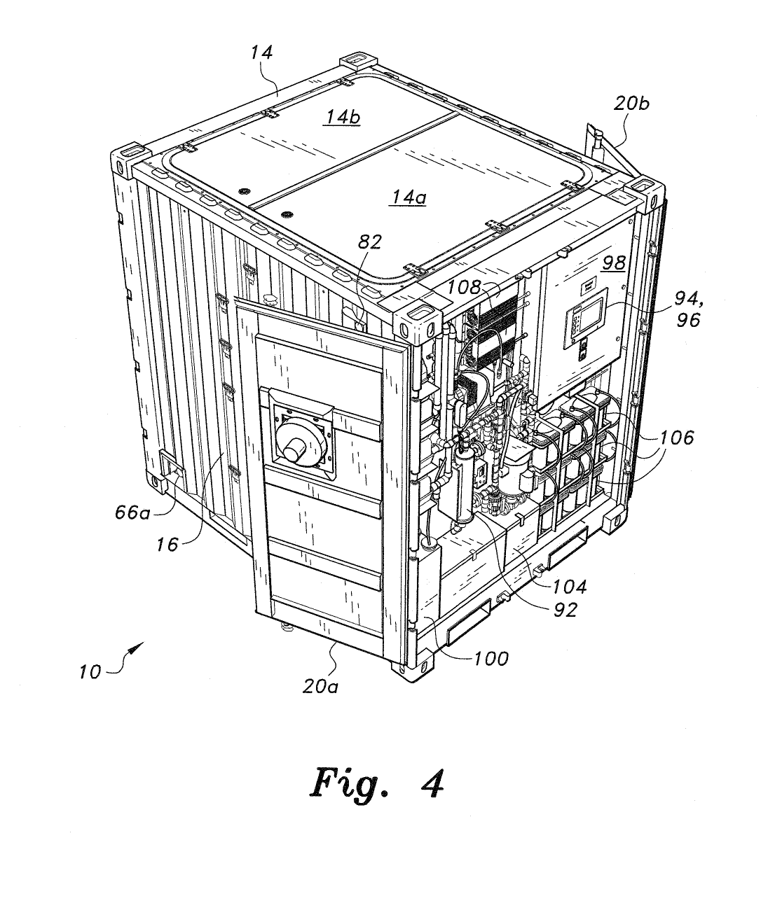

The treated water exiting the tank at this point is of high quality, although it is by no means potable. An ultraviolet disinfection unit 92 is provided for further treatment of the effluent. The ultraviolet disinfection unit 92 is shown in FIGS. 4 and 5, and is located just inside the front doors 20a and 20b of the container 10 with other electrical and electronic components and controls. The ultraviolet disinfection unit 92 is plumbed with the permeate pump assembly, including the permeate pump 76, that in turn draws permeate through the membrane filtration assembly 68 in the third or MBR chamber 38 of the wastewater treatment tank 28 described further above. Further treatment may be provided by a chlorine tablet dispenser 86 located at the main or primary outlet 124 from the tank, illustrated in FIG. 2 of the drawings. The chlorine tablet dispenser feeds chlorine into the flex hose 128, shown in the schematic of FIG. 8, and thus to the treated effluent storage bladder 126 or to onsite discharge via drain line 132 of FIG. 8.

FIG. 4 and particularly FIG. 5 provide views of the various electrical and other controls of the system, visible within the container 10 when the front doors 20a and 20b are open. The above-described system is controlled by a programmable logic controller (PLC) 94 located and communicating with a control panel and display or human-machine interface (HMI) 96 at the front of the master panel 98. The PLC 94 is programmed to receive data on water levels and conditions in the various chambers 34 through 38 of the tank 28, and to control the various pneumatic pumps 48a through 48d, the permeate pump 76, the airlift pump 78, and the ultraviolet disinfectant unit 92, as well as various other functions. Control of the system by the PLC 94 is fully automatic with no need for human intervention, when the system is operating properly. The control panel and display or HMI 96 permits the operator of the system to program or set periodic cleaning and other maintenance functions within the system. For example, it is anticipated that the membrane filtration assembly 68 will require semiannual cleaning for optimum efficiency and operation. This may be accomplished by mixing an appropriate cleaning solution in the chemical storage tank 100 and activating the cleaning program by means of the control panel and display or HMI 96 controlling the chemical feed pump 101. The cleaning process is then accomplished automatically, with the system backflushing the membrane filtration assembly with the cleaning chemicals. The system then automatically initiates normal operation after the cleaning process, with the cleaning chemicals being flushed from the system during normal operation. An additional spare parts storage container 102 and permeate pump spares container 104 for the storage and carriage of spares for all critical components are also provided adjacent to the chemical storage tank 100.

The various pumps, temperature and pressure sensors, the UV disinfection unit, etc., are all electrically powered. Electrical power may be supplied by a suitable external electrical power source connected to the external electrical power connector 90 (FIG. 1), or alternatively for a limited time by a self-contained electrical storage battery array 106 contained with the control and storage units and master panel 98 in the front of the container 10. A charger may be incorporated in the system to recharge the batteries 106 from external power, should the batteries become discharged from use. Electrical power from the storage batteries 106 is converted to AC by one or more inverters 108 for those components that require AC current. The front compartment may also contain an auxiliary light 110 and extension cord and reel 112 therefor, an auxiliary electrical power outlet 114, and main and heater power controls 116, as well as various other ancillary components. The two front doors 20a and 20b include vents, respectively 118a and 118b, and cooling fans within the vents (one such fan 120 is shown in the interior of the open door 20a in FIG. 4) in order to reduce heating within the closed front compartment when the doors 20a and 20b are closed.

FIG. 8 of the drawings provides a schematic view of an overall expeditionary or field latrine system incorporating the expeditionary water recycling system. The inlet 40 is shown in FIGS. 1 and 3, and the primary outlet 124, overflow outlet 84, and drain outlet 66a are all illustrated in the right side elevation view of FIG. 2, as well as being shown schematically in FIG. 8. A latrine L is contained within a container (tricon), and receives non-potable water for flushing and other purposes from a non-potable water supply W. Water pressure to the latrine L is provided by an NPW (non-potable water) pressurization system P in series with the water supply W. An additional NPW line 122 may be teed to the water supply line W to provide rinse water for various purposes as desired. Untreated blackwater flows from the latrine L to a latrine grinder pump station G by means of a first blackwater supply hose H1, and thence to the inlet port 40 for the first or primary clarifier chamber 34 in the container 10 of the expeditionary wastewater recycling system (EWRS) by means of a second blackwater supply hose H2 and normally open valve V 1. Electrical power is also preferably provided from the latrine L to the electrical power receptacle 90 of the container 10 via an electrical line E.

Treated water flows from the main or primary outlet 124 of the container 10 to a treated effluent storage bladder 126 by means of a flexible or other hose or line 128 and an open valve 130 and closed valve 134. Alternatively, the treated water may be discharged onsite by drain line 132 teed to the line 128 via a closed valve 130 and open valve 134. The treated effluent storage bladder 126, flexible hose or other line 128, and the various valves, connectors and fittings required for the operation of the system may be stored and carried in the rear and upper storage compartments 24 and 26 of the container 10 when the system is not deployed.

The expeditionary wastewater recycling system also provides for containment of any overflow due to excessive use or other reasons. The original blackwater storage bladder B normally used to collect effluent from the latrine L is connected to the blackwater supply hose or line H2 at a tee upstream of the normally open valve V1, with normally closed valves V2 and V3 provided in the hose or line H3 to the emergency storage bladder B. Another line or hose H4 extends from the overflow port or outlet 84 and the drain line outlet 66a of the container 10 to a tee with the hose or line H3, between the normally closed valve V3 and the bladder B. This hose or line H4 includes a normally open valve V4 just upstream of the tee between the normally closed valve V3 and the emergency storage bladder B.

In the event that the expeditionary wastewater recycling system is out of commission, the operator of the system may close the valve V1 to preclude flow into the tank 28 of the container 10 and open the valves V2 and V3 to allow the blackwater to flow into the emergency storage bladder B. This portion of the system is conventionally provided with expeditionary or field latrines L, and the containment of untreated blackwater in such bladders B to await pump-out is standard procedure. In the event that excess wastewater flows into the tank 28 of the container 10 before such excess flow can be controlled or regulated, the excess output flows through the emergency high water overflow line or hose H4 and through the normally open valve V4 and thence to the emergency storage bladder B.

Accordingly, the expeditionary wastewater recycling system is capable of handling and processing blackwater from a conventional latrine in an expeditionary or field environment, for an indeterminate but considerable period of time. The time span for the operation of such an installation may extend for months or even a few years, but the various subsystems of the system provide for such extended operation without need for significant maintenance. The system is substantially fully automated, only needing occasional periodic maintenance and internal cleaning during normal operation.

It is to be understood that the present invention is not limited to the embodiments described above, but encompasses any and all embodiments within the scope of the following claims.

We claim:

1. An expeditionary wastewater recycling system, comprising:
a portable shipping container having a floor, a top opposite the floor, a first side, a second side opposite the first side, a front panel, and a back panel;
a wastewater treatment tank disposed within the shipping container, the tank containing a plurality of vertically disposed panels therein, the panels defining a first chamber, a second chamber, and a third chamber, the first chamber defining a primary clarifier chamber, the second chamber defining a moving bed bioreactor chamber, and the third chamber defining a membrane bioreactor chamber;
a plurality of buoyant plastic media adapted for microbial growth thereon, the plastic media being disposed within the second chamber;
a plurality of air diffusers disposed within the first chamber and the second chamber; and
a membrane filter disposed within the third chamber.

2. The expeditionary wastewater recycling system according to claim 1, wherein the membrane filter has an inlet side and an outlet side, the system further comprising:
a permeate suction pump communicating with the outlet side of the membrane filter, the permeate suction pump drawing effluent through the membrane filter from the outlet side thereof;
a diffuser disposed at the inlet side of the membrane filter; and
a linear air scour pump communicating with the diffuser, the air scour pump and the diffuser pneumatically scouring the inlet side of the membrane filter.

3. The expeditionary wastewater recycling system according to claim 1, further comprising a wastewater disposal system having:
a latrine;
a grinder pump station receiving wastewater from the latrine, the wastewater recycling system receiving wastewater from the grinder pump station;
a treated effluent storage bladder receiving treated water from the wastewater recycling system; and
an emergency effluent storage bladder receiving overflow wastewater from the wastewater recycling system.

4. The expeditionary wastewater recycling system according to claim 1, further comprising a chlorine dispenser communicating with the primary outlet of the wastewater treatment tank.

5. The expeditionary wastewater recycling system according to claim 1, further comprising:
a plurality of pumps communicating with the wastewater treatment tank;
a programmable logic controller selectively controlling the pumps; and
a control panel communicating with the programmable logic controller.

6. The expeditionary wastewater recycling system according to claim 1, further comprising:
a rear storage compartment disposed within the shipping container between the back panel and the wastewater treatment tank; and
a top storage compartment disposed within the shipping container between the top and the wastewater treatment tank.

7. The expeditionary wastewater recycling system according to claim 1, further comprising an ultraviolet disinfectant unit disposed within the shipping container, the ultraviolet disinfectant unit communicating with the wastewater treatment tank.

8. An expeditionary wastewater recycling system, comprising:
a portable shipping container having a floor, a top opposite the floor, a first side, a second side opposite the first side, a front panel, and a back panel;
a wastewater treatment tank disposed within the shipping container, the tank containing a first chamber, a second chamber, and a third chamber, the first chamber defining a primary clarifier chamber, the second chamber defining a moving bed bioreactor chamber, and the third chamber defining a membrane bioreactor chamber;
a membrane filter disposed within the third chamber, the membrane filter having an inlet side and an outlet side;
a permeate suction pump communicating with the outlet side of the membrane filter, the permeate suction pump drawing effluent through the membrane filter from the outlet side thereof;
a diffuser disposed at the inlet side of the membrane filter; and
a linear air scour pump communicating with the diffuser, the air scour pump and the diffuser pneumatically scouring the inlet side of the membrane filter.

9. The expeditionary wastewater recycling system according to claim 8, wherein the wastewater treatment tank includes a plurality of vertically disposed panels defining the first chamber, the second chamber, and the third chamber, the system further comprising:
a plurality of buoyant plastic media adapted for microbial growth thereon, disposed within the second chamber; and
a plurality of air diffusers disposed within the first chamber and the second chamber.

10. The expeditionary wastewater recycling system according to claim 8, further comprising a wastewater disposal system having;
a latrine;
a grinder pump station receiving wastewater from the latrine, the wastewater recycling system receiving effluent from the grinder pump station;
a treated effluent storage bladder receiving treated water from the wastewater recycling system; and
an emergency effluent storage bladder receiving overflow wastewater from the wastewater recycling system.

11. The expeditionary wastewater recycling system according to claim 8, further comprising a chlorine dispenser communicating with the primary outlet of the wastewater treatment tank.

12. The expeditionary wastewater recycling system according to claim 8, further comprising:
a plurality of pumps communicating with the wastewater treatment tank;
a programmable logic controller selectively controlling the pumps; and
a control panel communicating with the programmable logic controller.

13. The expeditionary wastewater recycling system according to claim 8, further comprising:
a rear storage compartment disposed within the shipping container between the back panel and the wastewater treatment tank; and
a top storage compartment disposed within the shipping container between the top and the wastewater treatment tank.

14. The expeditionary wastewater recycling system according to claim 8, further comprising an ultraviolet disinfectant unit disposed within the shipping container, the ultraviolet disinfectant unit communicating with the wastewater treatment tank.

15. An expeditionary wastewater recycling system and a wastewater disposal system, comprising in combination:
a wastewater recycling system having:
a portable shipping container having a floor, a top opposite the floor, a first side, a second side opposite the first side, a front panel, and a back panel;
a wastewater treatment tank disposed within the shipping container, the tank containing a first chamber, a second chamber, and a third chamber, the first chamber defining a primary clarifier chamber, the second chamber defining a moving bed bioreactor chamber, and the third chamber defining a membrane bioreactor chamber; and
a wastewater disposal system having:
a latrine;
a grinder pump station receiving wastewater from the latrine, the wastewater recycling system receiving wastewater from the grinder pump station;
a treated effluent storage bladder receiving treated water from the wastewater recycling system; and
an emergency effluent storage bladder receiving overflow wastewater from the wastewater recycling system.

16. The expeditionary wastewater recycling system and a wastewater disposal system combination according to claim 15, wherein the wastewater treatment tank includes a plurality of vertically disposed panels defining the first chamber, the second chamber, and the third chamber, the system further comprising:
a plurality of buoyant plastic media adapted for microbial growth thereon, disposed within the second chamber; and
a plurality of air diffusers disposed within the first chamber and the second chamber.

17. The expeditionary wastewater recycling system and a wastewater disposal system combination according to claim 15, further comprising:
a membrane filter disposed within the third chamber of the wastewater treatment tank, the membrane filter having an inlet and an outlet side;
a permeate suction pump communicating with the outlet side of the membrane filter, the permeate suction pump drawing effluent through the membrane filter from the outlet side thereof;
a diffuser disposed at the inlet side of the membrane filter; and
a linear air scour pump communicating with the diffuser, the air scour pump and the diffuser pneumatically scouring the inlet side of the membrane filter.

18. The expeditionary wastewater recycling system and a wastewater disposal system combination according to claim 15, further comprising:
a chlorine dispenser communicating with the primary outlet of the wastewater treatment tank; and
an ultraviolet disinfectant unit disposed within the shipping container, the ultraviolet disinfectant unit communicating with the wastewater treatment tank.

19. The expeditionary wastewater recycling system and a wastewater disposal system combination according to claim 15, further comprising:
a plurality of pumps communicating with the wastewater treatment tank;
a programmable logic controller selectively controlling the pumps; and
a control panel communicating with the programmable logic controller.

20. The expeditionary wastewater recycling system and a wastewater disposal system combination according to claim 15, further comprising:
a rear storage compartment disposed within the shipping container between the back panel and the wastewater treatment tank; and
a top storage compartment disposed within the shipping container between the top and the wastewater treatment tank.
